(19) United States
(12) Patent Application Publication
(10) Pub. No.: US 2007/0013478 A1
(43) Pub. Date: Jan. 18, 2007

(54) Stand-alone weapons storage and locking rack with biometric input and processor driven release authorization, maintenance and inventory control

(76) Inventors: Rick Crigger, Lake Orion, MI (US); George W. Breadon, Clarkston, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/183,473

(22) Filed: Jul. 18, 2005

(51) Int. Cl. G06K 9/00

(52) U.S. Cl. 340/5.53; 211/64; 70/279.1; 340/5.5; 382/118

(57) ABSTRACT

A weapon access control system having a rack structure exhibiting a plurality of weapons in exposed and individually locked fashion. A processor operatively actuates each of the plurality of individual weapon locking mechanisms incorporated into the rack structure in response to successive biometric and weapon selection inputs communicating with the processor for determining at least one of user identification and weapon release authorization prior to the processor actuating the locking mechanism to release the weapon. An associated computer writeable medium operates with the processor and establishes a series of subroutines for establishing user identification, weapons rating, selective weapon release/reentry and associated maintenance and record keeping log reports.

### BACKGROUND OF THE INVENTION

1. Field of the Invention

The present invention relates generally to weapon storage and access assemblies. More specifically, the present invention discloses a weapon release assembly which combines the features of computerized rating and release/reentry of any number of weapons based upon individual biometric input parameters. Additional features include processor driven inventory control of weapons, substituting for manual record keeping, such as to provide for automatic lockout of weapons for maintenance when a desired number of use iterations have occurred.

2. Description of the Prior Art

The prior art is well documented with various examples of weapon storage assemblies. A common objective of such assemblies is to provide for secure retention of items such as firearms and, if possible, to establish some means for selective release to individuals, such as law enforcement officers.

A first example of the prior art is illustrated by the DSM Evidence Handling and Firearms Storage System brochure, DSM revised February 2003. Notable among the product descriptions in the DSM brochure are the Gun Storage Lockers, pages 9-10, as well as the system described in pages 5-6 and entitled “Audited Computer Controlled Evidence Storage System (A.C.C.E.S.S 500 Smart Locker)”.

The Smart Locker design does not disclose use with any type of firearm, but teaches computerized tracking and monitoring of a plurality of lockers, based on multiple levels of security. Itemized features of the Smart Locker device also include access card, pin number, or both in order to deposit evidence, as well as denying operator to secured evidence.

U.S. Pat. No. 6,260,300, issued to Klebes, teaches a closable container for locking, storing, enabling and disabling a device such as a firearm. A control system is responsive to a biometric input, such as a fingerprint scanning device, in order to both unlock the container or a trigger lock apparatus, as well as operation and firing of an electronically controlled firearm.

U.S. Pat. No. 5,701,770, issued to Cook, teaches a gun safe with dual methods of gaining access. The safe exhibits a three-dimensional and rectangular shaped housing and includes a hingedly openable end face. A solenoid locking mechanism is situated within the interior space of the gun safe on the top face thereof. A fingerprint scanning mechanism is positioned within the interior space of the gun safe and is adapted to detect the placement of a fingerprint adjacent thereto for reading and digital processing. Memory is included within the interior space of the gun safe for storing a fingerprint of at least one predetermined authorized user in a digital format. Verification means are connecting to the locking mechanism in order to transmit an unlock signal to the locking mechanism upon the matching of a scanned fingerprint with at least one of the fingerprints stored in the memory.

Other references of note include Vor Keller, U.S. Pat. No. 6,588,635 and U.S. Patent Application Publication No. 2002/0158095, teaching a safety holster mechanism for preventing unauthorized access to a firearm by unauthorized users, and a safety housing for use therewith. Another reference of note is Riener, U.S. Pat. No. 6,510,642, which teaches a locking device (multi-compartment cabinet) operating in cooperation with an identification device for accomplishing wireless exchange of at least one unambiguous identification code.

A further class of references teaches biometric reading and authorization schemes, whether or not related to weapons storage/access. References of note include Houvener, U.S. Pat. No. 6,424,249; Bromba, U.S. Pat. No. 6,836,556; Evans, U.S. Pat. No. 5,952,924; and WO 90/05965, this calibrating a biometric scheme using a person's individual body odor as the identifying parameter.

Other references disclosed teach biometric control associated with a weapon itself, and rather than a storage/locking facility for weapons retention. These include Wootton, U.S. Patent Application Publication No. 2002/0021206; Rapp, U.S. Pat. No. 6,678,984; and Klebes, U.S. Pat. No. 6,711,843.

### SUMMARY OF THE PRESENT INVENTION

The present invention discloses a rack supporting, powered and processor driven system for selective authorization and release of weapons, and such as for use by law enforcement agencies. The processor controlled rack assembly provides for secure locking of any plurality of firearms, in both individualized and visually evident fashion, the present invention further providing for modularity of design whereby any number of weapon supporting and individual racks can be incorporated into a single operating system.

As described, an aspect of the invention is the ability to communicate an individual determining biometric input (e.g. fingerprint, retinal scan) with a processor for the purpose of determining identity, weapons rating, and the like in order to selectively authorize and release for use individual weapons stored on the rack. The processor means is coupled with a solenoid locking mechanism and is actuated in both opening/release and (upon executing a reentering/returning procedure) closing positions to log out and re-log back in the weapons stored.

The processor performs additional functions such as maintaining a detailed record of weapons use (and by whom), as well as logging a number of times a given weapon is used in order to determine when maintenance is required. As further explained, the storage rack system according to the invention is particularly useful by smaller departments, e.g. 50 officers or less, and by which a convenient and effective (automatic) weapons storage and release system is desired.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective illustration of the weapons access control system according to a preferred embodiment of the present invention;

FIG. 2 is a partial perspective of the weapons access control system as illustrated in FIG. 1 and further showing a solenoid lock release mechanism associated with a given rack supported and locked firearm;

FIG. 3 is a schematic illustration of a touch screen associated with the weapons access system and which operates in cooperation with the biometric input reader also illustrated in FIG. 1;

FIG. 4 is a diagrammatic illustration of a series of protocol steps associated with one operating variant of the weapons access control system according to the present invention;

FIG. 5 is a schematic illustration of a weapons manager access control screen of a software based operating program in use with the present invention; and

FIG. 6 is a further schematic illustration of a weapons log screen in use with the operating program forming a part of the present invention.

### DETAILED DESCRIPTION OF THE PREFERRED EMBODIMENTS

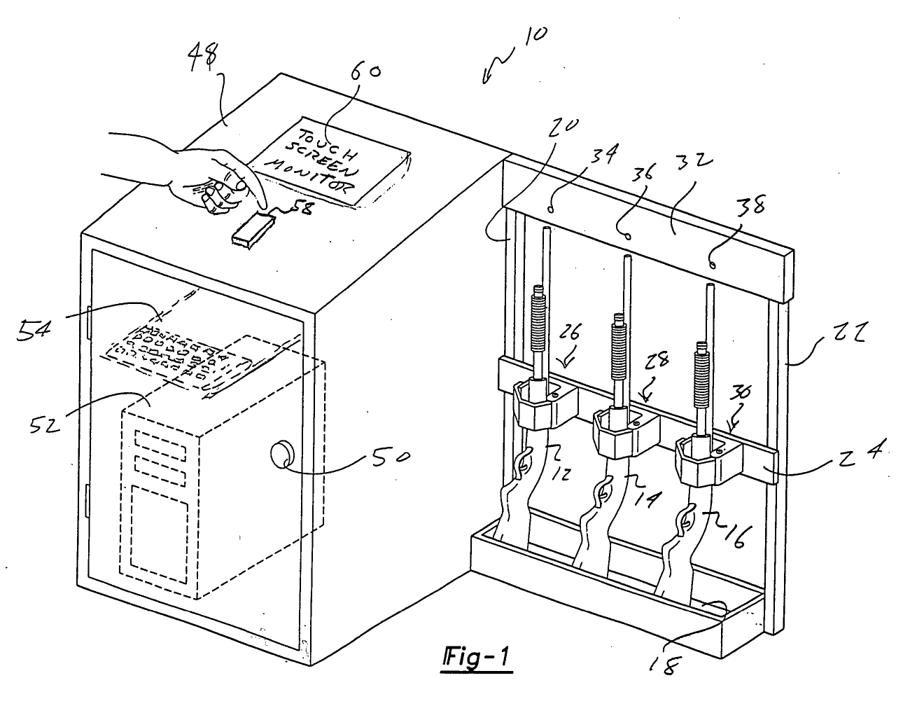

Referring now to FIG. 1, a weapon access system is illustrated at 10 according to a preferred embodiment of the present invention. As previously described, the present invention discloses a rack supporting, powered and processor driven system for selective authorization and release of weapons, and such as for use by law enforcement agencies. In particular, the present invention is particularly suited for use by smaller sized law enforcement departments and whereby significant savings are realized through the provision of a fully automated and fail-safe system for selectively releasing and reentering weapons on an individual rated basis, providing for automated maintenance scheduling of weapons, and providing for detailed log printouts of user activity.

A rack structure exhibits a plurality of weapons 12, 14, 16, et seq., in exposed and individually locked fashion. The rack structure in the embodiment illustrated includes a recessed and weapon stock seating base 18, as defined by an elongated rectangular enclosure. Upwardly extending sides 20 and 22 support a first parallel spaced midsection 24, supporting each of a plurality of individual weapon locking mechanisms 26, 28, 30, et seq., as well as a succeeding and upper spaced support 32 within which is defined a plurality of LED illuminating and indicating displays 34, 36, 38, et seq., associated with each of the weapons 12, 14, 16 and corresponding locking mechanisms 26, 28, 30. The wiring for the associated weapon locking mechanisms and LED displays typically runs internally within the rack structure, and such as within the upper spaced support 32.

While illustrated in one variant, it is understood that the rack structure can be single or double sided. It is also envisioned that any plurality of rack structures, either according to those described and illustrated herein or according to further potential designs, can be provided and by which any number of weapons, including both long barreled rifles, shotguns, etc., as well as potentially smaller sized handguns, stun guns, tasers, and other law enforcement related weaponry, can be safely and, in given instances visually, stored for quick identification, retrieval and reentry. It is also understood that, while the present invention provides for visual identification of all weapons secured within the rack structure, other potential variants are envisioned whereby weapons can be maintained in individually locked fashion, such as again including individual enclosures with transparent (see-through) surfaces, and the like.

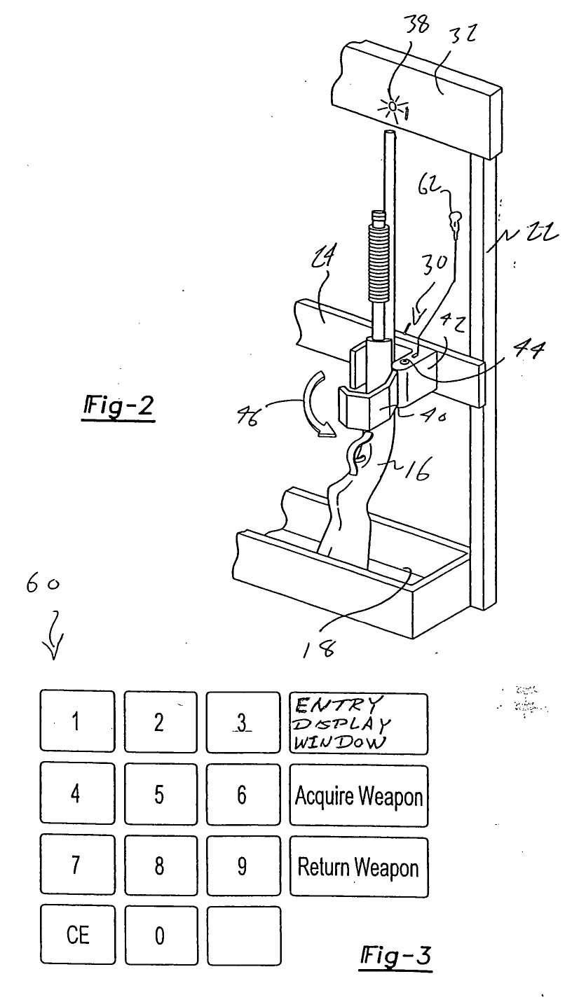

As is further illustrated in the enlarged sectional perspective of FIG. 2, each of the individual weapon locking mechanisms, illustrated here as selected mechanism 30, includes in the preferred embodiment a solenoid operated and arcuately configured latch 40, biasingly restrained (such as by springs or the like) in either an opened or closed position to a “U” shaped base component 42 fixed to the surface of the extending midsection and about a pivot point 44 established between the latch 40 and base 42 (see further opening direction of latch 40 as defined by arcuate arrow 46 in FIG. 2).

The design and configuration of the individual locking mechanisms is further understood to be susceptible to modification provided they operate in cooperation with the processor driven technology associated with the weapons access system and as will now be described. In the selected embodiment illustrated, the latch 40 closes to embrace the weapon body within the confines defined between the latch 40 and base 42, the configuration of the trigger assembly and stock preventing the weapon from being removed in an upward sliding fashion, whereby the recessed configuration of the seating base 18 preventing the weapon from being slidably removed in an opposite direction from an engaged locking mechanism.

Referring again to FIG. 1, a cabinet 48 is illustrated and which in the preferred embodiment is physically attached to the rack. The cabinet 48 can exhibit any desired configuration and, as illustrated, includes a front door 50, which is opened to reveal a PC hard drive 52. Additional components of the processor include a supported keyboard 54 and a touch screen monitor display 60 visible from a surface of the cabinet 48. As is known in the art, the processor is typically a computer, however other microprocessor-controlled devices can be employed, such as integrally formed with the cabinet structure, and within the scope of the invention.

In application the processor, upon the input of the following described criteria, operatively actuates any one or more of the individual weapon locking mechanisms 26, 28, 30, et seq., and in particular the solenoid operated latch associated with each mechanism, in order to release or to reenter a selected weapon. An initial process step for authorizing weapon release is provided by a biometric input reader 58 exhibited upon a face of the cabinet 48, typically its upper face and which is located in proximity to the monitor display 60.

The biometric input 58 is typically in the form of a finger or thumb print entry unit, however can also include a retinal eye scan device. The biometric input 58 communicates with the processor hard drive 52 for determining at least one of user identification and weapon release authorization, this information typically being stored in a lookup table associated with the processor hard drive.

A weapon acquisition/return screen is further illustrated at 60 in FIG. 1, as well as schematically also at 60 in FIG. 3. The screen 60 is exhibited upon the cabinet upper face and communicates with the processor, typically after biometric identification and weapon pre-qualification has occurred, in order to select an individual rated weapon as determined by the biometric input. This again occurs prior to the processor actuating the selected solenoid latch associated with the locking mechanisms to release the weapon.

The exemplary screen display 60 (see as shown in FIG. 3) includes a series of touch screen numeric buttons, such as 0-10, a clear CE button, an entry display window (e.g. such as “10” for shotgun and “22” for assault rifle), as well as weapon acquisition and weapon return buttons. As described previously, the processor operates to iteratively open and reengage a selected solenoid latch assembly, in one application ensuring that the same individual who logged out a given weapon is the one to log it back in. As again shown in FIG. 2, a key entered override 62 (also potentially a key card insert) can obtain emergency access to any or all weaponry, such as to a senior officer, this feature potentially being combined with a previous biometric input scan or operating as an entirely separate function.

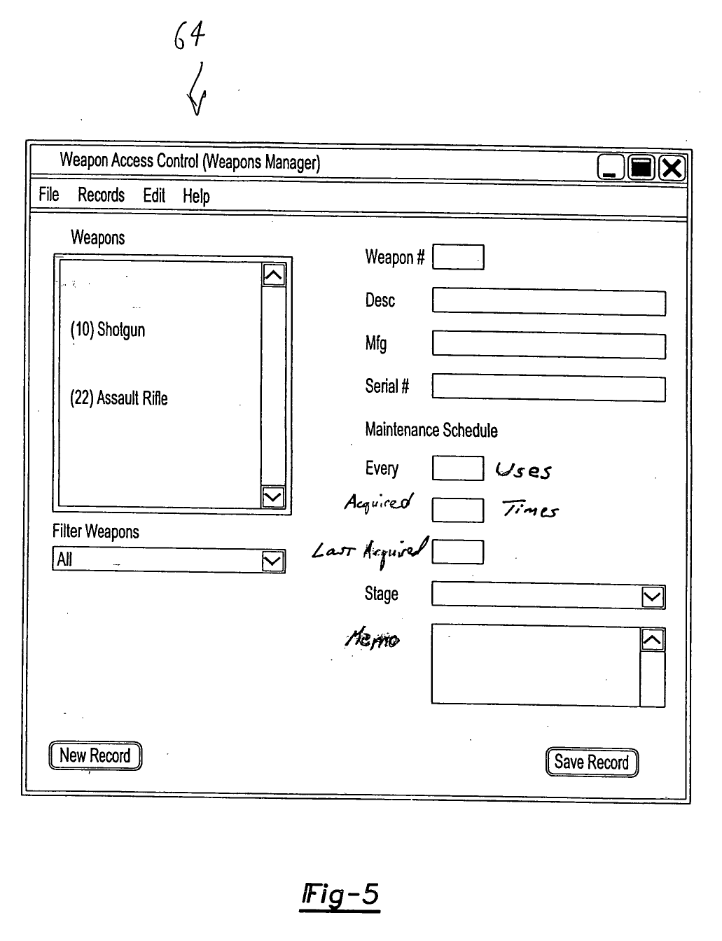

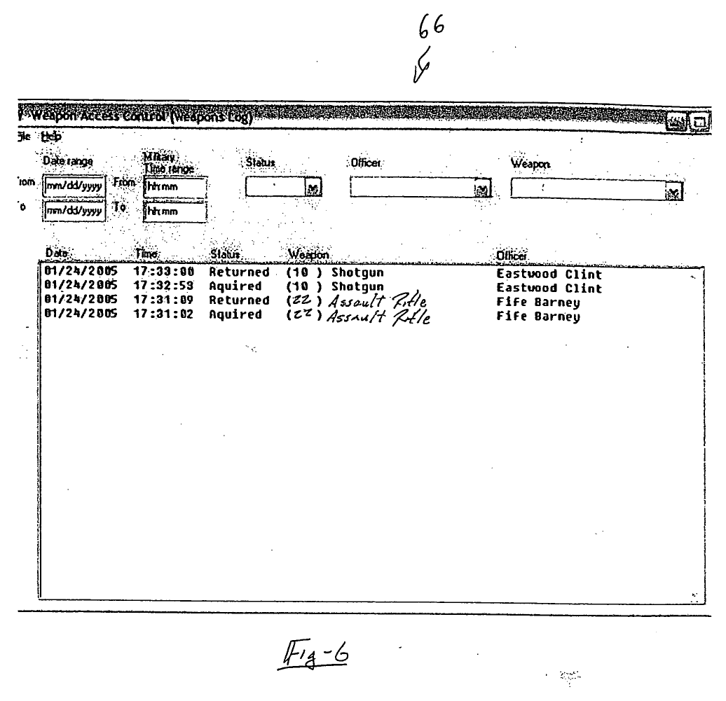

Referring now to FIGS. 5 and 6, a pair of exemplary screen displays associated with a software operator system in use with the PC components are shown and include a schematic illustration 64 (FIG. 5) of a weapons manager access control screen and a weapons log screen 66 (FIG. 6). The screens 64 and 66 are both illustrated in a generally Windows® software format and provide a series of features include weapon selection, maintenance scheduling (e.g. screen 64), as well as dates and times of individual acquisition and return (see screen 66).

The screens 64 and 66 are shown as being exemplary of the type and variety of screen displays which can be used with the operating software, and it is understood that any of a wide variety of differing software formats and coded applications can be employed in operating the processor controls. The information yielded by the screen illustrations 64 and 66 may further be broken down by date, weapon type, acquiring/returning officer, and the like (e.g. for weapons including, but not limited to, shotguns, assault rifles, etc.).

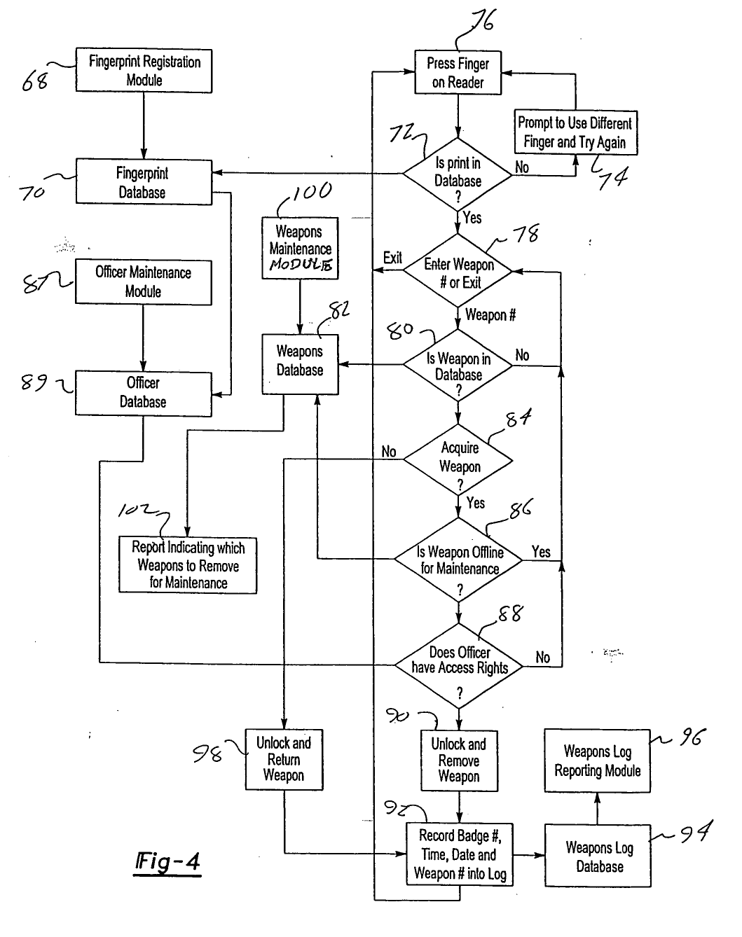

Referring to FIG. 4, a schematic illustration is shown of a protocol associated with the weapon access system of the present invention and includes a first step 68 by which a user activates the system via depressing the fingerprint registration module (also identified at 58 in FIG. 1 as the biometric input touch screen and which may again include retinal scanning as well as any other possible type of biometric identification). The individual thus entered into the system, via fingerprint database 70, through biometric input is given access only to weapons stored on the rack(s) which correspond to that individual's training and rating, and as is reflected by the most current data stored in the lookup table associated with the processor micro-control. Additional steps 72 query as to whether the user's fingerprint is retained in the database, if not whether a user must try a different biometric digit 74 and which is depressed upon the reader screen at step 76.

Assuming the individual is rated to select a given weapon, as previously defined by the biometric input, the user enters, at step 78, the desired weapon (see again touch screen 60 in the previous FIG. 1 and FIG. 3 illustrations). At step 80, the processor system determines if the desired weapon is located within the database (by conferring at step 82) and, if so, the weapon is acquired at step 84 (e.g. by the processor actuating the solenoid of a selected locking mechanism to an open biased position).

At step 86, the system determines if a selected weapon is offline (locked out by the processor) for required maintenance, which typically occurs after that weapon as been acquired and returned a specified number of times (iterations). In this instance, an authorized maintenance individual checks the weapon (such as through the use of the key access 62) and, having provided the necessary maintenance, reenters the weapon and resets the system.

Assuming the weapon is available for use and the individual is rated for that particular weapon, step 88 confirms the officer (see as referenced by supplying steps 87 and 89 and which correspond, respectively, to officer maintenance and officer database modules) has access rights and, successively at step 90, unlocks (opens the locking mechanism solenoid) to permit weapon removal. Additional step 92 corresponds to the processor recording a log of officer badge number, time, date and weapon release/acquisition information into the software generated log (see again in particular screen display 66). Succeeding steps 94 include the information obtained in step 92 being communicated to a weapons log database and, at 96, outputted into a weapons log reporting module.

Alternatively, and at step 84, a previously checked out weapon is returned to the rack system by the individual electing the unlock and return touch pad entry (step 98). This also corresponds to the return weapon entry illustrated on the touch screen display 60 of FIG. 3 and again by which the process re-actuates the solenoid locking mechanism to a reengaged position and upon the weapon being replaced within the rack structure to the designated locking mechanism and as further referenced by an associated LED display.

Finally, maintenance functions are identified by step 100, whereby a weapons maintenance module communicates with the database 82 previously identified and to generate a report (step 102) of those weapons which must be removed (after being locked out) for maintenance. The type of information entered per weapon item may also include type, manufacturer, date placed into service, weapon serial number, as well as again iterations of use prior to maintenance.

A computer writeable medium is also disclosed, such as in the form of a software program incorporated into a hard, drive, CD-ROM or the like, and which is in use with an associated processor for operating at least one of selective release and reentry of at least one of a plurality of weapons maintained in individually locked fashion. The computer writeable medium includes a first subroutine for establishing an identity of an individual through at least one biometric input parameter, a second subroutine for selecting a specified weapon through a processor readable entry, a third subroutine for determining an individual weapon access rating and a fourth subroutine for actuating a selected locking mechanism to an open position to release an authorized weapon to the individual.

Additional subroutines reengage the selected locking mechanism to a locked position upon reentry of a previously released weapon and establishing lockout access to a given weapon following a predetermined number of release/reentry iterations (i.e., requiring maintenance and resetting). Further subroutines provide key override access to the weapons to at least one biometrically identified individual, create a report log of weapon removal and required weapon maintenance, and display at least one of a weapon manager access control screen and a weapons log screen.

The present invention therefore provides an efficient, automated and highly detailed/customizable processor based system for regulating weapon release, reentry and maintenance scheduling, and which is an improvement over existing manual procedures for handling weapon release, return and maintenance.

Having described our invention, other and additional preferred embodiments will become apparent to those skilled in the art to which it pertains, and without deviating from the scope of the appended claims.

1. A weapon access control system, comprising:
a rack structure exhibiting a plurality of weapons in exposed and individually locked fashion;
a processor operatively actuating at least one of a plurality of individual weapon locking mechanisms incorporated into said rack structure; and
a biometric input communicating with said processor for determining at least one of user identification and weapon release authorization and prior to said processor actuating at least one locking mechanism.

2. The weapon access control system as described in claim 1, said biometric input further comprising at least one of fingerprint, thumbprint and retinal eye scan inputs.

3. The weapon access control system as described in claim 1, further comprising a weapon acquisition/return touch screen communicating with said processor.

4. The weapon access control system as described in claim 3, said locking mechanism each further comprising a solenoid operated latch responsive to said weapon acquisition/return touch screen to selectively release and reengage said weapon in iterative fashion.

5. The weapon access control system as described in claim 3, further comprising a cabinet attached to said rack structure, said processor further comprising a PC installed within said cabinet.

6. The weapon access control system as described in claim 5, said biometric input and said weapon acquisition/return screen each further comprising a display arranged within a face of said cabinet.

7. The weapon access control system as described in claim 1, further comprising a plurality of display indicators mounted to said rack structure at locations corresponding to each of said weapons, said processor communicating with and illuminating at least one selected display corresponding to a selected weapon locking mechanism.

8. The weapon access control system as described in claim 7, said display indicators each further comprising an LED display.

9. The weapon access control system as described in claim 1, further comprising a plurality of rack structures operatively communicated with said processor.

10. The weapon access control system as described in claim 7, each of said rack structures further comprising a recessed and weapon stock seating base, a parallel spaced midsection supporting said individual weapon locking mechanisms.

11. The weapon access control system as described in claim 10, further comprising each of said display indicators being mounted along an uppermost extending location of said rack structure.

12. The weapon access control system as described in claim 5, said processor further comprising a keyboard and a monitor display mounted within said cabinet.

13. The weapon access control system as described in claim 1, each of said weapon locking mechanisms further comprising a key override.

14. A computer writeable medium in use with an associated processor for operating at least one of selective release and reentry of at least one of a plurality of weapons maintained in individually locked fashion, said computer writeable medium further comprising:
a first subroutine for establishing an identity of an individual through at least one biometric input parameter;
a second subroutine for selecting a specified weapon through a processor readable entry;
a third subroutine for determining an individual weapon access rating; and
a fourth subroutine for actuating a selected locking mechanism to an open position to release an authorized weapon to the individual.

15. The computer writeable medium as described in claim 14, further comprising a succeeding subroutine for reengaging the selected locking mechanism to a locked position upon reentry of a previously released weapon.

16. The computer writeable medium as described in claim 14, further comprising a succeeding subroutine for locking access to a given weapon following a predetermined number of release/reentry iterations.

17. The computer writeable medium as described in claim 14, further comprising a succeeding subroutine for providing a key override access to the weapons to at least one biometrically identified individual.

18. The computer writeable medium as described in claim 14, further comprising a succeeding subroutine for creating a report log of weapon removal and required weapon maintenance.

19. The computer writeable medium as described in claim 14, further comprising a succeeding subroutine for displaying at least one of a weapon manager access control screen and a weapons log screen.

20. A weapon access control system, comprising:
at least one rack structure exhibiting a plurality of weapons in exposed and individually locked fashion, each of said rack structures further comprising a recessed and weapon stock seating base, a parallel spaced midsection supporting each of a plurality of individual weapon locking mechanism;
a processor operatively actuating said individual weapon locking mechanisms and incorporated into a cabinet secured to said rack structure, each of said locking mechanisms further comprising a solenoid operated latch assembly;
a biometric input reader exhibited upon a face of said cabinet and communicating with said processor for determining at least one of user identification and weapon release authorization; and
a weapon acquisition/return screen exhibited upon said cabinet and communicating with said processor to select an individual rated weapon as determined by said biometric input and prior to said processor actuating said at least one locking mechanism to release said weapon.
